(19) United States
(12) Patent Application Publication
(10) Pub. No.: US 2015/0051039 A1
(43) Pub. Date: Feb. 19, 2015

(54) Planetary Gear Set Module with Limited Slip

(71) Applicant: ArvinMeritor Technology, LLC, Troy, MI (US)

(72) Inventors: Christopher Keeney, Troy, MI (US); Mark Smith, Troy, MI (US); Lon Cooper, Pasadena, CA (US)

(73) Assignee: ArvinMeritor Technology, LLC, Troy, MI (US)

(21) Appl. No.: 13/969,898

(22) Filed: Aug. 19, 2013

(51) Int. Cl. F16H 48/22

(52) U.S. Cl. CPC F16H 48/22
USPC 475/149; 475/293

(57) ABSTRACT

A planetary gear set module having planetary gear set and a biasing member. The biasing member may exert a biasing force on a component of the planetary gear set and may permit the component to rotate when sufficient torque is provided to overcome the biasing force.

### TECHNICAL FIELD

This patent application relates to a planetary gear set module with limited slip capability.

### BACKGROUND

A planetary gear mechanism is disclosed in U.S. Pat. No. 5,006,100.

### SUMMARY

In at least one embodiment, a planetary gear set module is provided. The planetary gear set module may include a housing, a first shaft, a planetary gear set, and a biasing member. The first shaft may be configured to rotate about an axis. The planetary gear set may be disposed in the housing and may include a sun gear, a ring gear, a plurality of planet gears, and a planet gear carrier. The sun gear may be fixedly disposed with respect to the first shaft. The ring gear may be disposed proximate the housing. The plurality of planet gears may be disposed between the sun gear and the ring gear. The planet gear carrier may operatively connect the plurality of planet gears to a second shaft. The sun gear, ring gear, and the planet gear carrier may be members of a set of normally fixed components of which one member of the set is normally stationary with respect to the housing. The biasing member may exert a biasing force on a member of the set of normally fixed components. The biasing member may permit the member of the set of normally fixed components to rotate about the axis when the second shaft is inhibited from rotating and sufficient torque is provided by the first shaft to overcome the biasing force.

In at least one embodiment, a planetary gear set module is provided. The planetary gear set module may include a housing, an electric motor, a planetary gear set, and a first biasing member. The electric motor may be disposed in the housing and may include a stator and a rotor. The stator may be fixedly positioned with respect to the housing. The rotor may be disposed on a first shaft that rotates about an axis with respect to the stator. The planetary gear set may be disposed in the housing and may be configured to be driven by the electric motor. The planetary gear set may include a sun gear, a ring gear, a plurality of planet gears, and a planet gear carrier. The sun gear may be fixedly disposed on the first shaft. The ring gear may be disposed proximate the housing. The plurality of planet gears may be moveably disposed between the sun gear and the ring gear. The planet gear carrier may operatively connect the plurality of planet gears to a second shaft. The first biasing member may extend between the ring gear and the housing. The first biasing member may permit the sun gear, the plurality of planet gears, and the ring gear to rotate together as a unit about the axis when the second shaft is inhibited from rotating and sufficient torque is provided by the first shaft to overcome a biasing force exerted by the first biasing member against the ring gear.

### BRIEF DESCRIPTION OF THE DRAWINGS

FIG. 1 is a section view of an embodiment of a planetary gear set module.

FIG. 2 is a section view of a second embodiment of a planetary gear set module.

FIG. 3 is a section view of a third embodiment of a planetary gear set module.

FIG. 4 is a section view of a fourth embodiment of a planetary gear set module.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

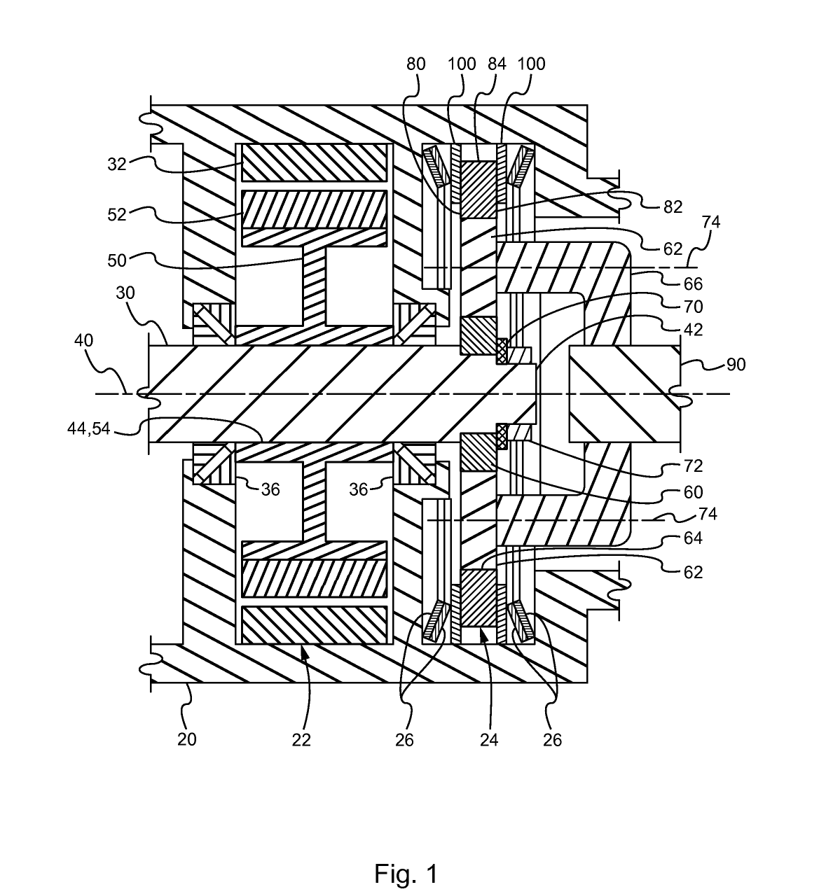

Referring to FIG. 1, a portion of an exemplary planetary gear set module 10 is shown. The planetary gear set module 10 may be provided with a motor vehicle, such as a truck, bus, or automobile. The planetary gear set module 10 may be part of a vehicle drivetrain that may provide torque to one or more traction wheels. For example, the planetary gear set module 10 may be an electric motor module that may be part of a drivetrain of a hybrid electric vehicle and may provide torque to one or more traction wheels. In addition, the planetary gear set module 10 may be part of a transmission, transfer case, or similar torque transmission system. For instance, the planetary gear set module 10 may be provided with a transmission or transfer case and may be associated or provided with an electric motor to provide power take-off capability and/or may function as a torque limiter to inhibit torque overloads from damaging downstream components. In FIGS. 1 through 4, the planetary gear set module 10 is illustrated with an electric motor or illustration purposes may include a housing 20, an electric motor 22, a planetary gear set 24, and at least one biasing member 26.

The housing 20 may be provided to receive various components of the planetary gear set module 10. In addition, the housing 20 may facilitate mounting of the planetary gear set module 10 to the vehicle. The housing 20 may include multiple housing portions that may be fastened together in any suitable manner to facilitate assembly of the planetary gear set module 10. For simplicity, the housing 20 is illustrated as a single component in FIGS. 1-4.

The electric motor 22, if provided, may be disposed in the housing 20. In at least one embodiment, the electric motor 22 may be disposed adjacent to the planetary gear set 24. The electric motor 22 may be electrically coupled to a power source, such as a battery and/or capacitor that may provide and/or store electrical energy. The electric motor 22 may provide torque to a rotor shaft or first shaft 30 when electrical current is received. In addition, the electric motor 22 may generate electrical current in response to rotation of the first shaft 30. For example, electrical current may be generated during regenerative braking. In at least one embodiment, the electric motor 22 may include the first shaft 30, a stator 32, and a rotor 34.

The first shaft 30 may be rotatably disposed in the housing 20. For example, the first shaft 30 may be rotatably supported by one or more bearings 36. The first shaft 30 may extend along an axis 40 and may have an end 42 and a spline 44. The end 42 may be disposed proximate the planetary gear set 24. The spline 44 may be disposed along a portion of the exterior surface or outside diameter of the first shaft 30. The teeth of the spline 44 may extend generally parallel to the axis 40 to help secure the rotor 34 as will be described in more detail below.

The stator 32 may be fixedly disposed with respect to the housing 20. For example, the stator 32 may be disposed on or proximate to an internal surface of the housing 20. The stator 32 may be radially disposed about the axis 40 and may include a plurality of windings as is known by those skilled in the art.

The rotor 34 may be spaced apart from but disposed in close proximity to the stator 32. The rotor 34 may rotate with respect to the stator 32 and may include a rotor mounting plate 50 and one or more rotor elements 52.

The rotor mounting plate 50 may be configured as a ring or disk that may extend around the axis 40. In at least one embodiment, the rotor mounting plate 50 may have a generally I-shaped cross section. The rotor mounting plate 50 may be fixedly coupled to the first shaft 30. For example, the rotor mounting plate 50 may have a hole through which the first shaft 30 may extend. A spline 54 may be disposed in the hole. The teeth of the spline 54 may extend generally parallel to the axis 40 and may mate with the teeth of the spline 44 on the first shaft 30 to inhibit rotation of the rotor 34 with respect to the first shaft 30. The rotor mounting plate 50 may support the rotor element 52.

One or more rotor elements 52 may be disposed on the rotor mounting plate 50 adjacent to the stator 32. The rotor elements 52 may have any suitable configuration. For example, the rotor elements 52 may be magnets or windings or ferromagnetic material. If magnets are provided, the magnets may be permanent magnets. A ferromagnetic material may not be permanently magnetized.

The planetary gear set 24 may be disposed in the housing 20 and may be configured to provide a desired gear reduction ratio. The planetary gear set 24 may include a sun gear 60, a plurality of planet gears 62, a ring gear 64, and a planet gear carrier 66.

The sun gear 60 may be disposed proximate the center of the planetary gear set 24. The sun gear 60 may be configured to rotate about the axis 40 and may include a hole and a gear portion.

The hole may be configured to receive the first shaft 30. In at least one embodiment, the hole may be a through hole that may extend through the sun gear 60. A spline may be provided on an interior surface or inside diameter of the sun gear 60 that at least partially defines the hole. The teeth of the spline may extend generally parallel to the axis 40 and may engage and mate with a similarly configured spline disposed on the exterior surface of the first shaft 30 to fixedly position the sun gear 60 on the first shaft 30 and inhibit rotation of the sun gear 60 with respect to the first shaft 30. One or more fasteners, such as a washer 70 and a nut 72 may be disposed proximate the end 42 of the first shaft 30 to inhibit axial movement of the sun gear 60 or movement of the sun gear 60 along the axis 40 with respect to the first shaft 30.

The gear portion may be disposed on an exterior surface or outside diameter of the sun gear 60 that may be disposed opposite the first shaft 30. The gear portion may include a set of teeth may be configured to engage the planet gears 62.

The planet gears 62 be spaced apart from each other and may be rotatably disposed between the sun gear 60 and the ring gear 64. Each planet gear 62 may include a set of teeth that may mesh with teeth on the sun gear 60 and teeth on the ring gear 64. Each planet gear 62 may be configured to rotate about a different axis 74. The axes of rotation for the planet gears 62 may extend substantially parallel to the axis 40.

The ring gear 64 may be disposed between the housing 20 and the planet gears 62. The ring gear 64 may include a plurality of teeth that may be disposed around an inside diameter and may face toward the sun gear 60. The teeth on the ring gear 64 may mesh with teeth on the planet gears 62. The ring gear 64 may include a first surface 80, a second surface 82, and a third surface 84. The first surface 80 may extend away from the axis 40 and may face toward the electric motor 22. The second surface 82 may be disposed opposite the first surface 80 and may be disposed substantially parallel to the first surface 80 in one or more embodiments. The third surface 84 may extend from the first surface 80 to the second surface 82. The third surface 84 may be an outside circumference of the ring gear 64. The third surface 84 may be non-fixedly disposed with respect to the housing 20. As such, the ring gear 64 may rotate about the axis 40 and with respect to the housing 20 under various operating conditions as will be discussed in more detail below. The third surface 84 may be spaced apart from the housing 20 to facilitate rotation. Alternatively, the third surface 84 may engage the housing 20 but may not be press fit or otherwise secured to the housing 20 in one or more embodiments.

The planet gear carrier 66 may be configured to support and position the planet gears 62. The planet gear carrier 66 may include a plurality of openings that may be substantially equidistantly spaced apart from each other. Each opening may receive a fastener, such as a pin, for coupling a planet gear 62 to the planet gear carrier 66. The planet gear carrier 66 may operatively connect the planet gears 62 to a second shaft 90 or output shaft. For example, the planet gear carrier 66 may include a hole that may receive the second shaft 90. The second shaft 90 may help operatively connect the planetary gear set module 10 to one or more traction wheels. The second shaft 90 may be rotatably disposed in the housing 20. For example, the second shaft 90 may be rotatably supported by one or more bearings and may extend along and rotate about the axis 40.

At least one component of the planetary gear set 26 may be normally fixed or normally in a stationary position with respect to the housing 20. For instance, the ring gear 64 may normally be stationary with respect to the housing 20 while the sun gear 60 and planet gear carrier 66 are permitted to move or the sun gear 60 may be stationary with respect to the housing 20 while the ring gear 64 and planet gear carrier 66 are permitted to move, or the planet gear carrier 66 may be stationary with respect to the housing while the sun gear 60 and ring gear 64 are permitted to move. These normally stationary components are designated a set of normally fixed components herein. As such, the set of normally fixed components may include the sun gear 60, the ring gear 64, and the planet gear carrier 66. One of these components may normally be fixed or in a stationary position with respect to the housing, but may be permitted to move when the biasing force exerted by one or more biasing members 26 is overcome.

At least one biasing member 26 may be provided to exert a biasing force on a normally fixed member of the planetary gear set, such as the sun gear 60, the ring gear 64, or the planet gear carrier 66, to normally inhibit movement or rotation of the normally fixed component with respect to the housing 20 while permitting the normally fixed component to move, slip, or rotate about the axis 40 with respect to the housing 20 under high torque operating conditions, such as when significantly different dynamic inertial torques may be experienced by the planetary gear set module 10 or vehicle drivetrain. In the embodiments shown, the ring gear 64 is depicted as the normally fixed component for illustration purposes. For example, the electric motor 22 may rotate with a relatively high rotational inertia. The planetary gear set 24 may reduce the rotational speed of the electric motor 22 and increase the torque delivered to the second shaft 90 and components connected downstream of the second shaft 90. Thus, the rotational inertia of the electric motor 22 may transmit torque to the planetary gear set 24, second shaft 90, and components connected downstream of the second shaft 90 even when components disposed downstream of the planetary gear set module 10 are inhibited from moving or rotating. This rotational inertia may twist and store potential energy in downstream components or fatigue or damage such components during sudden deceleration events, such as “locking up” or inhibiting rotation of a traction wheel that is connected to the planetary gear set module 10 or lock up or failure of a downstream component or accessory like a pump that may be driven by the planetary gear set module 10. Permitting limited slip or rotation of the ring gear 64 may help mitigate twisting, fatigue, or damage to the planetary gear set module 10 or downstream components. As such, the biasing member 26 may permit a member of the set of normally fixed component, such as the ring gear 64, to rotate about the axis 40 when the second shaft 90 is inhibited from rotating about the axis 40 and sufficient torque is provided by the first shaft 30 to overcome the biasing force exerted by the biasing member 26. As a result, the biasing member 26 may permit the sun gear 60, planet gears 62, and the ring gear 64 to rotate together about the axis 40 when the second shaft 90 is inhibited from rotating, which may mean that the second shaft 90 is able to rotate about the axis 40 but is substantially slowed or restrained from doing so or the second shaft 90 is held in a stationary position and not permitted to rotate about the axis 40. Moreover, the biasing member 26 may permit the sun gear 60, planet gears 62, and ring gear 64 to rotate together about the axis 40 but not with respect to each other when sufficient torque is provided to overcome the biasing force exerted by the biasing member 26 against the ring gear 64. As such, the sun gear 60, planet gears 62, and ring gear 64 may be stationary with respect to each other, but may rotate together as a unit with respect to the housing 20 about the axis 40. The biasing member 26 may also inhibit the ring gear 64 from rotating about the axis 40 under normal operating conditions, such as when the second shaft 90 is free to rotate about the axis 40 or when the second shaft 90 is inhibited from rotating but sufficient torque is not provided by the first shaft 30 to overcome the biasing force exerted by the biasing member 26.

The biasing member 26 may have any suitable configuration. For example, the biasing member 26 may be configured as a conical spring, such as a Belleville washer, a clutch diaphragm spring, a wave spring, or a coil spring. In addition, the biasing member 26 may have a ring-like configuration and may extend continuously around the axis 40. The biasing member 26 may be disposed between the ring gear 64 and the housing 20. In at least one embodiment, the biasing member 26 may exert an axial biasing force, or a biasing force that acts substantially parallel to the axis 40. Biasing members 26 may also be provided in a stacked configuration in which multiple biasing members 26 may be disposed adjacent to each other and between the housing 20 and the ring gear 64. Moreover, biasing members 26 that do not have a ring-like configuration may be arranged around the axis 40 and may be spaced apart from each other as will be discussed in more detail below. In addition, one or more biasing members 26 may be fixedly disposed with respect to the housing 20 or ring gear 64. For instance, a biasing member 26 may be affixed or fixedly disposed on the housing 20 but not the ring gear 64, or may be affixed or fixedly disposed on the ring gear 64 but not the housing 20.

Referring to FIG. 1, a first embodiment of an planetary gear set module 10 is shown. In this embodiment, the ring gear 64 may be spaced apart from the housing 20 and may be supported by a plurality of biasing members 26 and a pair of friction plates 100. A plurality of biasing members 26 may be provided on opposite sides of the ring gear 64. Alternatively, a single biasing member 26 may be provided on opposite sides of the ring gear 64 in one or more embodiments. Each biasing member 26 may extend from the housing 20 to a friction plate 100. In FIG. 1, two friction plates 100 are shown that are spaced apart from each other and disposed on opposite sides of the ring gear 64. One or more friction plates 100 may have a ring-like configuration and may extend continuously around the axis 40. Each friction plate 100 may be disposed between the ring gear 64 and a biasing member 26 and may engage the housing 20. For example, a first friction plate 100 may engage the first surface 80 of the ring gear 64 and may be disposed between the ring gear 64 and a first biasing member 26 while a second friction plate 100 may engage the second surface 82 of the ring gear 64 and may be disposed between the ring gear 64 and a second biasing member 26. Alternatively, additional friction plates 100 may be provided or the friction plates 100 may be omitted in one or more embodiments.

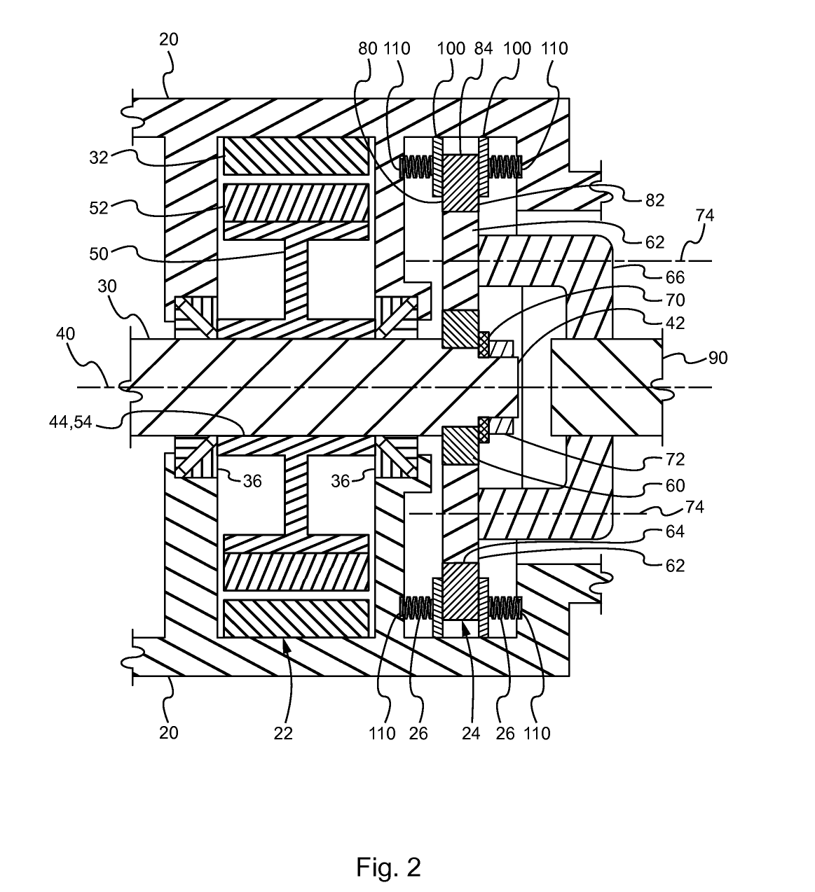

Referring to FIG. 2, another embodiment of a planetary gear set module is shown. In this embodiment, the biasing members 26 are configured as coil springs. A plurality of biasing members 26 may be provided that may be spaced apart from each other and may be radially disposed about the axis 40. Each biasing member 26 may be coaxially disposed with another biasing member 26 located on an opposite side of the ring gear 64. In addition, one or more biasing members 26 may be received in a corresponding pocket 110 of the housing 20. Each pocket 110 may be configured as a blind hole or indentation that may receive a portion of a corresponding biasing member 26. Moreover, one or more pockets 110 may be coaxially disposed with another pocket 110 in one or more embodiments. Each pocket 110 may help align and position a corresponding biasing member 26. Additional friction plates 100 may be provided or the friction plates 100 may be deleted, in which case one or more biasing members 26 may engage the ring gear 64.

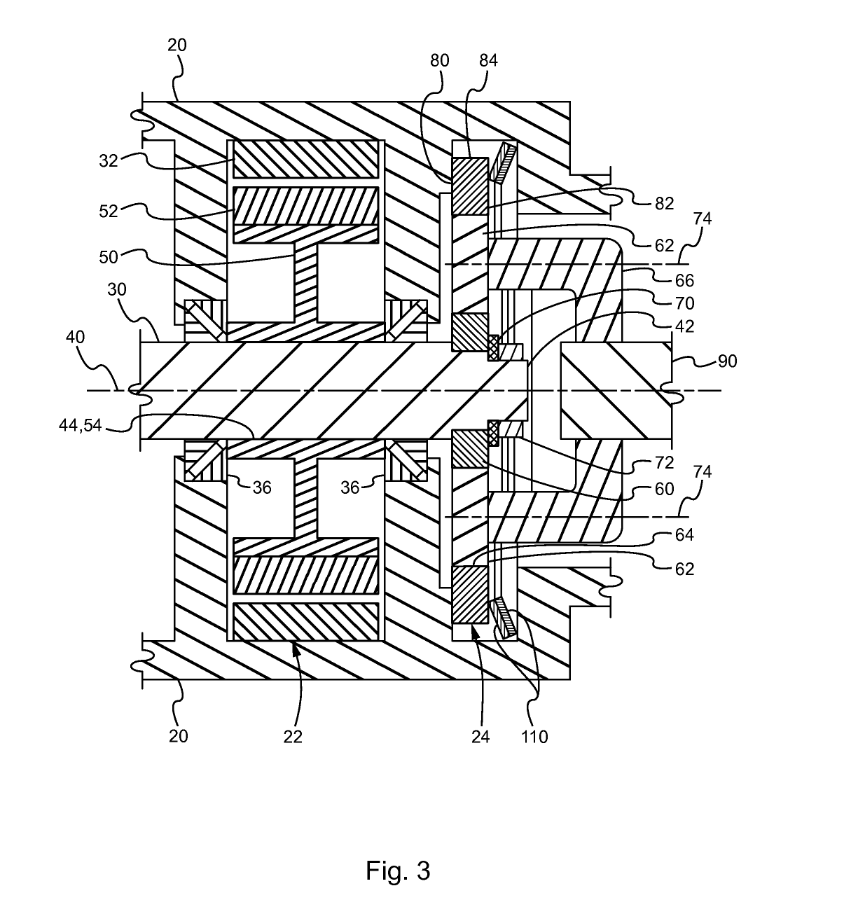

Referring to FIG. 3, another embodiment of a planetary gear set module is shown. In this embodiment, one or more biasing members 26 may be provided on a single side of the ring gear 64 rather than on opposite sides of the ring gear 64 as shown in FIGS. 1 and 2. The biasing member(s) 26 may bias the ring gear 64 against the housing 20. As such, a biasing member 26 may extend between the housing 20 and the ring gear 64 and may be disposed opposite a surface of the ring gear 64 that may engage the housing 20 or another stationary component. In one or more embodiments, the biasing member 26 may bias the ring gear 64 axially toward the electric motor 22 such that the first surface 80 of the ring gear 64 may engage the housing 20. In FIG. 3, a plurality of biasing members 26 are shown in a stacked arrangement, but it is contemplated that a greater or lesser number of biasing members 26 may be provided. In addition, one or more friction plates 100 may be provided between the biasing member 26 and the ring gear 64 as previously discussed.

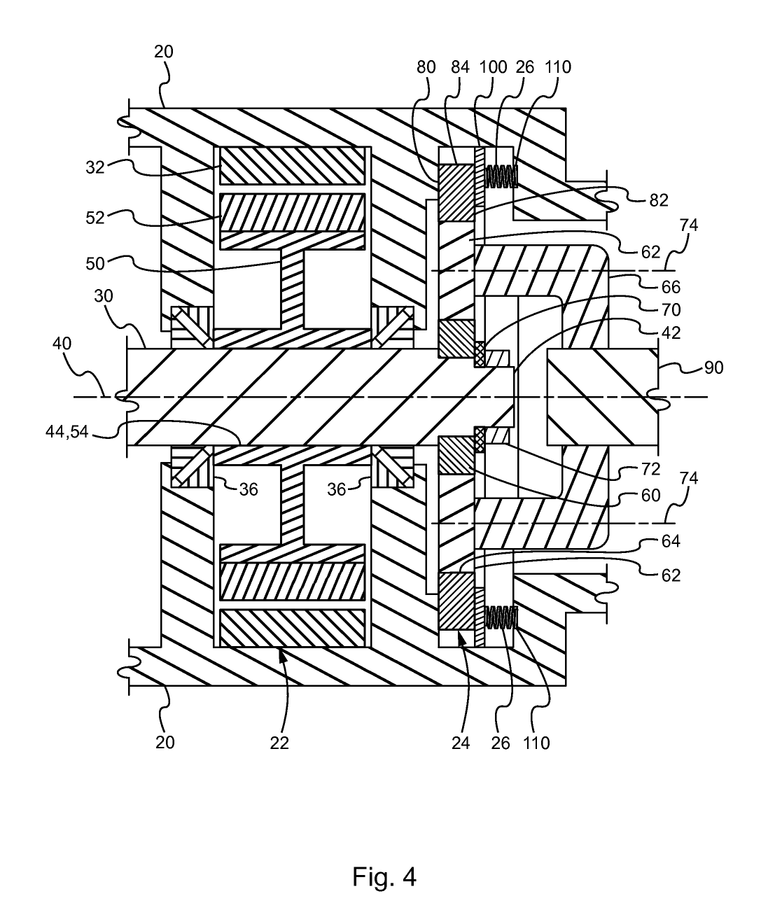

Referring to FIG. 4, another embodiment of a planetary gear set module is shown. In this embodiment, one or more biasing members 26 configured as coil springs may be provided on a single side of the ring gear 64. The biasing members 26 may be spaced apart from each other, may be arranged around the axis 40, and may be received in corresponding pockets 110 similar to the embodiment shown in FIG. 2. One or more friction plates 100 may be provided between the ring gear 64 and one or more biasing members 26. Alternatively, friction plates 100 may be omitted in one or more embodiments.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A planetary gear set module comprising:
a housing;
a first shaft that is disposed in the housing and configured to rotate about an axis;
a planetary gear set that is disposed in the housing, the planetary gear set including:
a sun gear disposed proximate the first shaft;
a ring gear disposed proximate the housing;
a plurality of planet gears disposed between the sun gear and the ring gear; and
a planet gear carrier that operatively connects the plurality of planet gears to a second shaft;
wherein the sun gear, the ring gear, and the planet gear carrier are members of a set of normally fixed components, wherein one member of the set of normally fixed components is normally stationary with respect to the housing; and
a biasing member that exerts a biasing force on a member of the set of normally fixed components, wherein the biasing member permits the member of the set of normally fixed components to rotate about the axis when the second shaft is inhibited from rotating and sufficient torque is provided by the first shaft to overcome the biasing force.

2. The planetary gear set module of claim 1 wherein the biasing member inhibits the ring gear from rotating about the axis when the second shaft is free to rotate.

3. The planetary gear set module of claim 1 wherein the biasing member inhibits the ring gear from rotating with respect to the housing when the second shaft is inhibited from rotating and sufficient torque is not provided by the first shaft to overcome the biasing force.

4. The planetary gear set module of claim 1 wherein the biasing member extends between the ring gear and the housing.

5. The planetary gear set module of claim 1 wherein the ring gear is spaced apart from the housing.

6. The planetary gear set module of claim 1 further comprising an electric motor that is disposed in the housing and that includes a stator and a rotor that is disposed on a first shaft that is configured to rotate about an axis, wherein the electric motor is disposed adjacent to the planetary gear set.

7. The planetary gear set module of claim 1 wherein the biasing member biases the ring gear against the housing.

8. The planetary gear set module of claim 6 wherein the biasing member biases the ring gear axially toward the electric motor.

9. The planetary gear set module of claim 1 wherein the biasing member extends continuously around the axis.

10. A planetary gear set module comprising:
a housing;
an electric motor disposed in the housing that includes:
a stator that is fixedly positioned with respect to the housing; and
a rotor that is disposed on a first shaft that rotates about an axis with respect to the stator;
a planetary gear set that is disposed in the housing and configured to be driven by the electric motor, the planetary gear set including:
a sun gear fixedly disposed on the first shaft;
a ring gear disposed proximate the housing;
a plurality of planet gears rotatably disposed between the sun gear and the ring gear; and
a planet gear carrier that operatively connects the plurality of planet gears to a second shaft; and
a first biasing member that extends between the ring gear and the housing, wherein the first biasing member permits the sun gear, plurality of planet gears and ring gear to rotate together as a unit about the axis when the second shaft is inhibited from rotating and sufficient torque is provided by the first shaft to overcome a biasing force exerted by the first biasing member against the ring gear.

11. The planetary gear set module of claim 10 wherein the ring gear has a first surface and a second surface disposed opposite the first surface, wherein the first surface engages the housing and the first biasing member engages the second surface.

12. The planetary gear set module of claim 10 further comprising a friction plate disposed between the ring gear and the first biasing member, wherein the ring gear has a first surface and a second surface disposed opposite the first surface, wherein the first surface engages the housing and the friction plate engages the second surface.

13. The planetary gear set module of claim 12 wherein the friction plate extends continuously around the axis and engages the housing.

14. The planetary gear set module of claim 12 wherein the housing further comprises a pocket, wherein the first biasing member is received in the pocket.

15. The planetary gear set module of claim 10 further comprising a second biasing member that extends from the ring gear to the housing and is disposed on an opposite side of the ring gear from the first biasing member.

16. The planetary gear set module of claim 15 wherein the second biasing member extends continuously around the axis and the ring gear is spaced apart from the housing.

17. The planetary gear set module of claim 15 wherein the first and second biasing members are conical springs.

18. The planetary gear set module of claim 15 wherein the housing includes a first pocket that receives the first biasing member and a second pocket disposed opposite the first pocket that receives the second biasing member.

19. The planetary gear set module of claim 18 wherein the first and second biasing members are coil springs that are coaxially disposed.

20. The planetary gear set module of claim 15 further comprising a first friction plate disposed between the ring gear and the first biasing member and a second friction plate disposed between the ring gear and the second biasing member.
